(19) United States
(12) Patent Application Publication
(10) Pub. No.: US 2006/0133739 A1
(43) Pub. Date: Jun. 22, 2006

(54) Silicon optical bench-based optical sub-assembly and optical transceiver using the same

(76) Inventors: Byoung Whi Kim, Daejeon (KR); Seung Hyun Cho, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/153,870

(22) Filed: Jun. 13, 2005

(30) Foreign Application Priority Data
Dec. 16, 2004 (KR) 10-2004-0107095
Apr. 22, 2005 (KR) 10-2005-0033779

(51) Int. Cl. G02B 6/36

(52) U.S. Cl. 385/88; 385/89; 385/92

(57) ABSTRACT

The silicon optical bench-based optical sub-assembly of the present invention includes an optical fiber ferrule, a silicon optical bench-based optical device, a support and an optical adaptor. The silicon optical bench-based optical device is provided with an optical device chip for converting optical signals into electrical signals and vice versa, and a groove for placing the optical fiber of the optical fiber ferrule so that the optical fiber can be optically coupled to the optical device chip. The support is provided with concave mounts for mounting the ferrule and the silicon optical bench-based optical device thereon. The optical adaptor is connected to the support, and is configured to secure an external optical fiber so that the external optical fiber can be optically coupled to the optical fiber of the optical fiber ferrule.

### RELATED APPLICATIONS

The present application is based on, and claims priority from, Korean Application Number 2004-0107095, filed Dec. 16, 2004, and Korean Application Number 2005-0033779, filed Apr. 22, 2005, the disclosure of which are incorporated by reference herein in its entirety.

### BACKGROUND OF THE INVENTION

1. Field of the Invention

The present invention relates generally to an optical transceiver and, more particularly, to a transmitter optical sub-assembly and a receiver optical sub-assembly, and an optical transceiver using the transmitter optical sub-assembly and the receiver optical sub-assembly.

2. Description of the Related Art

In general, an optical transceiver is applied to an optical transmission system, and refers to a module that transmits optical signals emitted from a light-emitting element via an optical fiber and detects optical signals received from the optical fiber using a light-receiving element.

FIG. 1 is a view showing the schematic construction of a conventional optical transceiver 10.

As shown in FIG. 1, the conventional optical transceiver 10 basically includes a light-emitting element 11 and a light-receiving element 12 packaged in TO-can form, a Printed Circuit Board (PCB) 13 configured to operate the light-emitting element 11 and receive detection signals from the light-receiving element 12, a casing 14 configured to contain the light-emitting element 11, the light-receiving element 12 and the PCB 13, and a pin connector 15 for electrical signal connection.

FIGS. 2a and 2b are views showing the construction of optical sub-assemblies 21 and 22 that are used to construct optical interfaces with the light-emitting element 11 and the light-receiving element 12 packaged in conventional TO-can form.

FIG. 2a is a view showing the construction of the optical sub-assembly 21 for the light-emitting element 11 that is applied to the conventional optical transceiver 10 shown in FIG. 1, and FIG. 2b is a view showing the construction of an optical sub-assembly 22 for the light-receiving element 12. As shown in FIGS. 2a and 2b, the light-emitting element 11 and the light-receiving element 12 are disposed in the optical sub-assemblies 21 and 22 that are interfaces with optical lines and have receptacle shapes so as to be easily handled and that are packaged using metallic TO-cans 23 and 24. A plurality of pins 25 and 26 connected to the optical sub-assemblies 21 and 22 are connected to the anodes and cathodes of laser diodes or photodiodes disposed in the light-emitting element 11 and the light-receiving element 12.

As described above, in the conventional optical transceiver 10, the light-emitting element 11 and the light-receiving element 12 are disposed in metallic packages that are called TO-cans 23 and 24. An expensive piece of equipment, called a cap welder, is required to fabricate the TO-cans 23 and 24, and an expensive piece of laser welding equipment, called a laser welder, is required to achieve connections to optical fibers. When the optical transceiver 10 is fabricated using the expensive equipment, a processing cost becomes high, so that a disadvantage arises in that the price of a finished product becomes high. When coupling to optical fibers is performed using the laser welding equipment, an active alignment method is adopted, so that disadvantages arise in that a process is complicated and a lengthy manufacturing period is required.

Furthermore, the conventional optical transceiver 10 additionally requires optical systems having special structures, such as lens caps, which adjust the paths of light to achieve high-quality transmission and reception of optical signals, in the parts that are located at the front ends of the TO-cans 23 and 24 and connected to the optical connectors, so that a problem arises in that some cost is added.

### SUMMARY OF THE INVENTION

Accordingly, the present invention has been made keeping in mind the above problems occurring in the prior art, and an object of the present invention is to provide a Transmitter Optical Sub-Assembly (TOSA) and a Receiver Optical Sub-Assembly (ROSA) that can be easily fabricated in small sizes without using expensive active alignment equipment, unlike light-transmitting and light-receiving elements packaged in TO-can form, and an optical transceiver using the TOSA and the ROSA.

In order to accomplish the above object, the present invention provides a silicon optical bench-based optical sub-assembly, including an optical fiber ferrule provided with an optical fiber therein; a silicon optical bench-based optical device provided with an optical device chip for converting optical signals into electrical signals and vice versa, and a groove for placing the optical fiber of the optical fiber ferrule so that the optical fiber can be optically coupled to the optical device chip; a support provided with concave mounts for mounting the ferrule and the silicon optical bench-based optical device thereon; and an optical adaptor connected to the support and configured to secure an external optical fiber so that the external optical fiber can be optically coupled to the optical fiber of the optical fiber ferrule.

In addition, the present invention provides an optical transceiver including, at least one optical sub-assembly having, an optical fiber ferrule provided with an optical fiber therein, a silicon optical bench-based optical device provided with an optical device chip for converting optical signals into electrical signals and vice versa, and a groove for placing the optical fiber of the optical fiber ferrule so that the optical fiber can be optically coupled to the optical device chip, a support provided with concave mounts for mounting the ferrule and the silicon optical bench-based optical device thereon, and an optical adaptor connected to the support and configured to secure an external optical fiber so that the external optical fiber can be optically coupled to the optical fiber of the optical fiber ferrule; a PCB connected to the optical sub-assembly and configured to perform control, amplification and identification of electrical signals on the silicon optical bench-based optical device; a pin-type electric connector connected to the PCB and configured to function as an interface with external devices; and a casing configured to contain the optical sub-assembly, the PCB and the pin-type electric connector.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the schematic construction of a conventional optical transceiver;

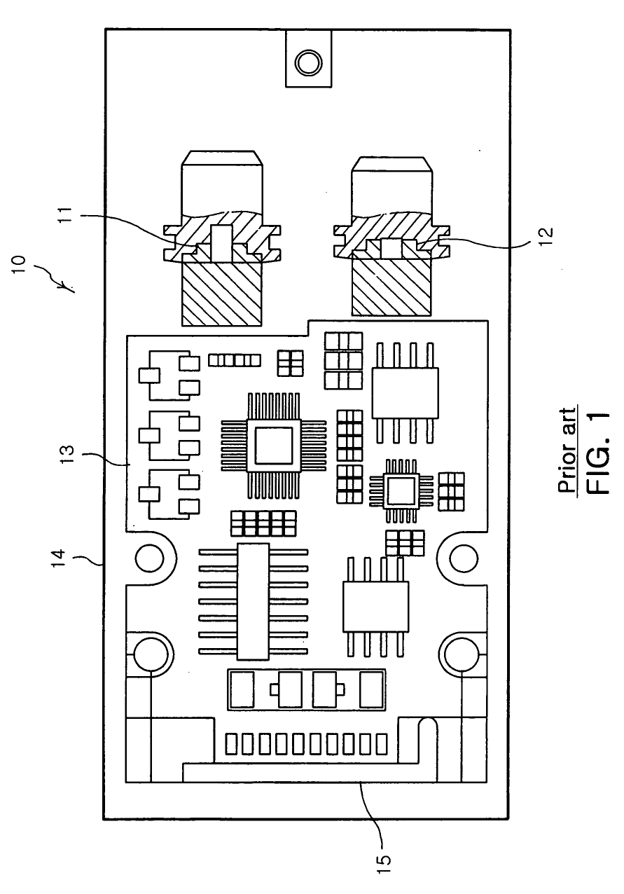

FIGS. 2a and 2b are views showing the construction of optical sub-assemblies that are used to construct optical interfaces with a light-emitting element and a light-receiving element packaged in conventional TO-can form;

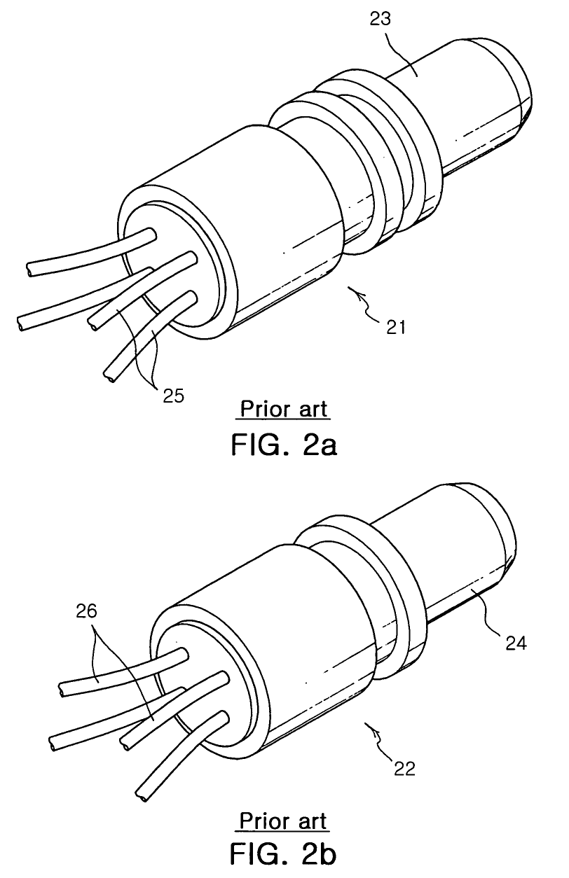

FIGS. 3a and 3b are exploded and assembled views of an optical sub-assembly 300 according to an embodiment of the present invention, respectively;

FIGS. 4a and 4b are views showing the construction of silicon optical bench-based optical devices according to an embodiment of the present invention;

FIG. 5 is a view showing the construction of an optical fiber ferrule according to an embodiment of the present invention;

FIG. 6 is a view showing the construction of an optical transceiver using a silicon optical bench-based TOSA and ROSA in accordance with an embodiment of the present invention; and

FIG. 7 is a side view of a metallic casing and a T-type metallic lid.

### DESCRIPTION OF THE PREFERRED EMBODIMENTS

Reference now should be made to the drawings, in which the same reference numerals are used throughout the different drawings to designate the same or similar components.

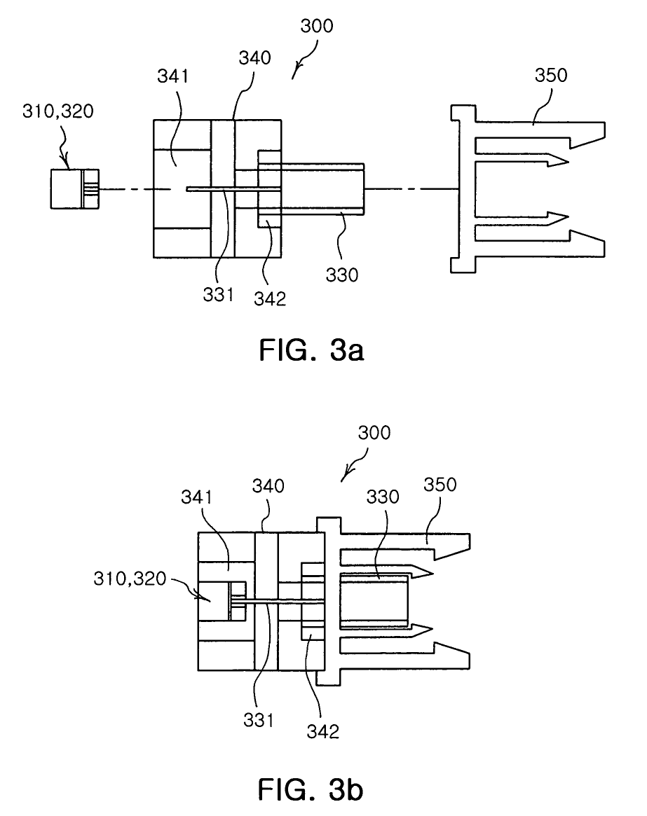

FIGS. 3a and 3b are exploded and assembled views of an optical sub-assembly 300 according to an embodiment of the present invention, respectively.

FIG. 3a is an exploded view of the optical sub-assembly 300 according to the embodiment of the present invention, and FIG. 3b is an assembled view of the optical sub-assembly 300. Referring to FIGS. 3a and 3b, the optical sub-assembly 300 includes a silicon bench-based optical device that includes a light-emitting element 310 or a light-receiving element 320, an optical fiber ferrule 330, a support 340 and an optical adaptor terminal 350.

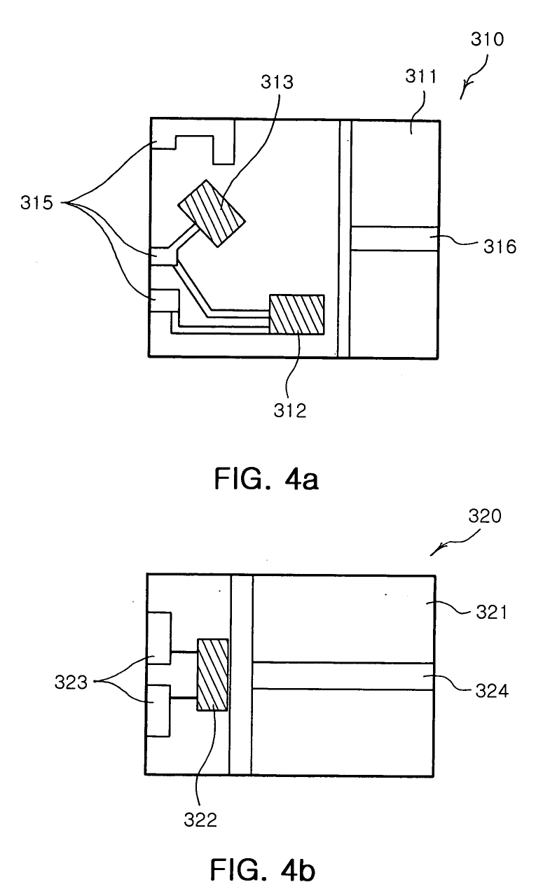

The light-emitting element 310 functions to convert electrical signals into optical signals. The light-emitting element 310, as shown in FIG. 4a, is constructed in such a way that optical device chips, which include a laser diode 312 and a power monitoring photodiode 313, and a V-groove 316, which is used to passively align the anode and cathode terminals 315 of the optical device chips 312 and 313 with optical fibers, are placed on a silicon optical bench 311. The laser diode 312 outputs corresponding optical signals in response to electrical signals. The photodiode 313 functions to detect part of the light emitted from the laser diode 312 and then adjust the intensity of the optical output of the laser diode 312 using a feedback circuit. The laser diode 312 and the photodiode 313 are bonded onto the silicon optical bench 311 using solder bumps by flip chip bonding. An optical fiber connected to the optical fiber ferrule 330 is inserted into the V-groove 316 formed in the silicon optical bench 311 in a passive alignment manner, and is optically coupled to and aligned with the laser diode 312. Furthermore, the optical fiber connected to the optical fiber ferrule 330 is combined with the silicon optical bench 311 using an ultraviolet-setting epoxy resin.

The light-receiving element 320 functions to convert optical signals into electrical signals. The light-receiving element 320, as shown in FIG. 4b, is constructed in such a way that an optical signal receiving photodiode 322 and a V-groove 324, which is used to passively align the anode and cathode terminals of the photodiode 322 with optical fibers, are placed on a silicon optical bench 321. The photodiode 322 functions to convert externally input optical signals into corresponding electrical signals. The photodiode 322 is bonded onto the silicon optical bench 321 using a solder bump in a flip chip bonding manner. The optical fiber connected to the ferrule 330 is inserted into the V-groove 324, which is formed in the silicon optical bench 321, in a passive alignment manner, and is optically coupled to and aligned with the photodiode 322. Furthermore, the optical fiber connected to the optical fiber ferrule 330 is combined with the silicon optical bench 311 using an ultraviolet-setting epoxy resin. The silicon optical bench-based optical devices 310 and 320 are coated with silicon gel or an encapsulating agent, thus being protected from the external environment.

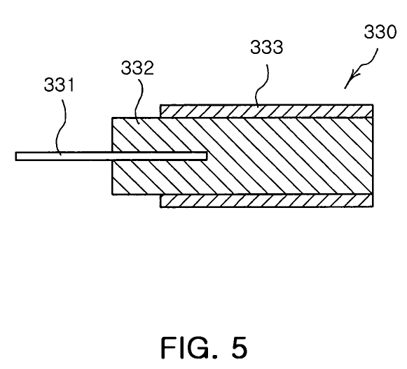

The optical fiber ferrule 330 includes an optical fiber 331 and is optically coupled to an active optical device chip, that is, the laser diode 312 or the photodiode 313 or 322, which is disposed in the light-emitting element 310 or the light-receiving element 320, in a receptacle manner, thus easily achieving optical coupling between optical lines. In the optical fiber ferrule 330, the optical fiber 331 is disposed in a hole formed in a stub 332, as shown in FIG. 5. The stub 332 functions to secure the optical fiber 331. Furthermore, the stub 332 is protected by an outside hollow cylinder 333. The outside hollow cylinder 333 aims to increase the mechanical strength of the optical fiber ferrule 330, and has a structure that surrounds the stub 332.

The optical fiber ferrule 330 functions to easily optically couple the active optical device chip with the optical connector. The silicon optical bench-based light-emitting and light-receiving elements 310 and 320 employ a passive alignment method, so that the construction and location of the optical fiber ferrule 330 are very important. The location of the optical fiber ferrule 330 on the metallic support 340 influences the performance of the optical transceiver. The optical fiber ferrule 330 is implemented using a combination of the optical fiber 331, the stub 332 and the outside hollow cylinder 333 having arbitrary lengths. Only when the elements 331, 332 and 333 are coupled to each other and have minimal errors, the optical transceiver can has desired optical coupling characteristics. The respective elements 331, 332 and 333 constituting the optical fiber ferrule 330 should have mechanically and thermally stable performance, so that the elements 331, 332 and 333 should be made of ceramic-based materials having the same characteristics, and careful attention should be paid to the process of coupling the elements 331, 332 and 333 so as to minimize errors.

The support 340 is a block in which the silicon optical bench-based optical device 310 or 320 is mounted, and is one of the important blocks for constructing the optical transceiver 300. The concave mount 341 for mounting the silicon optical bench-based optical device 310 or 320 is formed on the top of one side of the support 340. A concave mount 342 for mounting the optical fiber ferrule 330 is further formed on the top of the other side of the support 340. Accordingly, the silicon optical bench-based optical device 310 or 320 and the optical fiber ferrule 330 can be inserted into the concave mounts 341 and 342, respectively, and can be arranged in a receptacle manner to easily achieve an optical connection between optical lines. The support 340 is made of metal, and functions to prevent the characteristic degradation of an optical device caused by electromagnetic interference and super high frequency interference and supplement the mechanical strength of the silicon optical bench-based optical device 310 or 320 and the silicon optical bench 311 or 321.

The optical adaptor terminal 350 is combined with the support 340, and functions to secure and arrange the optical fiber ferrule 330 and an external optical fiber (not shown) so that an optical connection can be established between the optical fiber ferrule 330 and the external optical fiber. The optical adaptor terminal 350 has a structure capable of holding the external optical fiber so that the outside hollow cylinder 333 of the optical fiber ferrule 330 is inserted into the optical adaptor terminal 350 and the external optical fiber is secured and aligned with the optical fiber ferrule 330 in the opposite direction.

The optical sub-assembly 300 according to the present invention may be manufactured as described below.

After the optical fiber ferrule 330 has been attached onto the metallic support 340, the silicon optical bench-based light-emitting or light-receiving element 310 or 320 is placed on the mount 341 of the metallic support 340. At this time, the optical coupling between the optical fiber 330, which exists in the ferrule 330, and the light-emitting or light-receiving element 310 or 320 is realized through the V-groove 316 or 324 formed in the silicon optical bench 311 or 321 in a passive alignment manner. After the passive alignment, the light-emitting or light-receiving element 310 or 320 and the optical fiber ferrule 330 are secured onto the metallic support 340 using an ultraviolet-setting epoxy resin to have a certain mechanical strength. After the above-described process, the optical adaptor terminal 350 is combined with the metallic support 340 by fitting the optical adaptor terminal 350 over one side of the support 340.

As described above, the silicon optical bench-based light-emitting and light-receiving elements 310 and 320 according to the present invention can be aligned using the V-grooves 316 and 324 formed on the silicon optical benches 311 and 321 in a passive alignment manner so as to achieve coupling with the optical fibers, so that it is not necessary to use expensive equipment, such as a laser welder, for active alignment. Additionally, since the light-emitting and light-receiving elements 310 and 320 are mounted on the surfaces of the inexpensive silicon optical benches 311 and 321, the fabrication method of the present invention has the advantage of improving cost competitiveness compared to the conventional TO-can type packaging method.

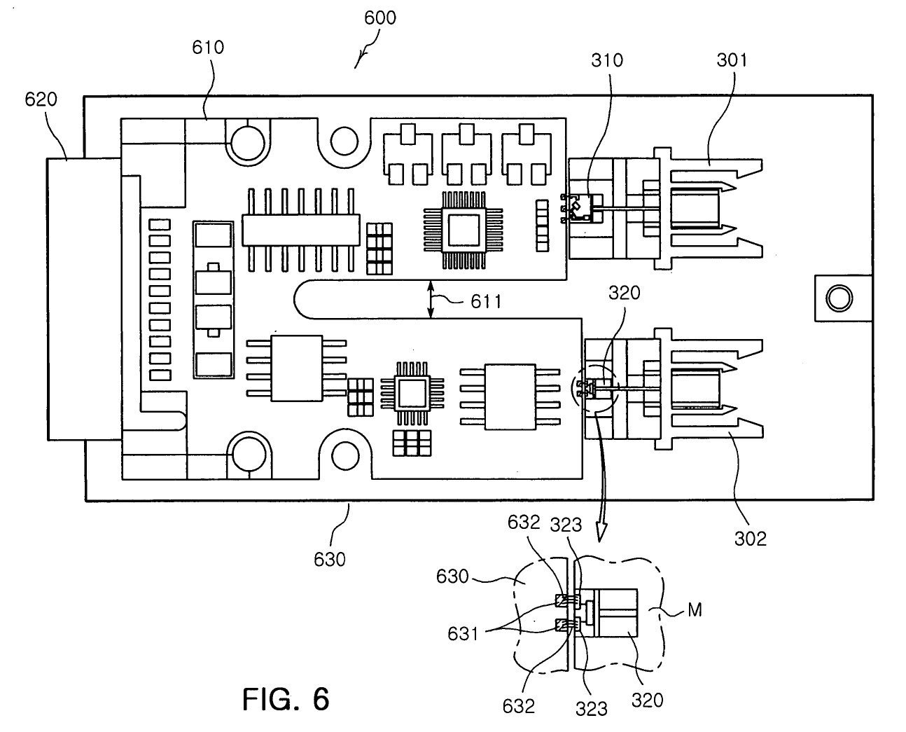

FIG. 6 is a view showing the construction of an optical transceiver using a silicon bench-based TOSA and ROSA in accordance with an embodiment of the present invention.

Referring to FIG. 6, the optical transceiver 600 of the present invention includes a TOSA 301 and a ROSA 302 provided with silicon optical bench-based light-emitting and light-receiving elements 310 and 320 that function to perform conversion between electrical signals and optical signals, a PCB 610 electrically connected to the light-emitting and light-receiving elements 310 and 320 and configured to control, amplify or identify electrical signals, a pin-type electric connector 620 connected to the PCB 610, and a metallic casing 630 configured to shield the silicon optical bench-based light-emitting and light-receiving elements 310 and 320 and the PCB 610 from electromagnetic interference and high frequency interference.

The PCB 610 is electrically connected to the light-emitting and light-receiving elements 310 and 320, and functions to control, amplify or identify electrical signals. The PCB 610 is composed of an optical transmission part and an optical reception part, and the optical transmission part is formed of a general laser diode driver Integrated Circuit (IC). The laser diode driver IC functions to combine a data signal with the bias signal of a laser diode and drive the laser diode. Like the optical transmission part, the optical reception part is composed of amplifier ICs that perform the same function as a conventional optical receiver. In detail, the optical reception part is composed of a Trans Impedance Amplifier (TIA) and a Limiting Amplifier (LA). However, unlike the conventional optical receiver, the silicon optical bench-based light-receiving element 320 is located spaced apart from the TIA. Furthermore, since the light-receiving element 320 and the TIA are very sensitive to external electromagnetic interference and external high frequency interference, it is necessary to pay more careful attention than when fabricating the PCB 610. That is, in the case of the conventional optical receiver, a TO-can type metallic package is employed, so that the metallic package itself can effectively protect the photodiode and the TIA from electromagnetic inference and high frequency interference. However, since the silicon optical bench-based optical elements 310 and 320 do not utilize such metallic packages, they are exposed to external electromagnetic interference and external high frequency interference. In general, such electromagnetic interference and high frequency interference highly influence the sensitivity of the optical receiver. In order to solve the problem caused by the interference, the grounding of the PCB must be ensured at the time of fabricating the PCB and the PCB must share a ground with the metallic casing. Additionally, the noise of power used to drive the optical receiver must be minimized, and electric passive elements, such as inductors and capacitors, having appropriate values must be additionally disposed at appropriate positions between the amplifier ICs to ensure operational performance in a specific frequency band.

Although the optical transmission part and the optical reception part share the same PCB 610, ground terminals must be completely isolated from and spatially separated from each other. For the grounding, the grounding separation of the transmission part from the reception part must be achieved along all the signal paths ranging from the pin-type electric connector 620 to the PCB 610. Additionally, in order to prevent the performance degradation of the reception part caused by electromagnetic interference through the internal space of the metallic casing 630, it is preferred that a space 611 be formed such that the transmission part and the reception part can be arranged on the PCB 610 to be spaced apart from each other by a certain distance, as illustrated in FIG. 6.

The pin-type electric connector 620 is electrically connected to the PCB 610, and functions as an interface with external devices. When the pin-type electric connector 620 is connected to the PCB 610, the ground pins of a plurality of pins of the pin-type electric connector 620 must be connected to the ground terminal of the PCB 610 and the casing 630 so as to suppress electromagnetic interference.

The light-emitting element 310 and the light-receiving element 320 are connected to the PCB 610 by wire bonding. The light-emitting element 310 and the light-receiving element 320 may be connected to the PCB 610 using a single wire. However, the silicon optical bench-based light-emitting and light-receiving elements 310 and 320 may be connected to the PCB 610 using a plurality of wires to reduce inductance so as to prevent performance degradation caused by electromagnetic interference. For example, as illustrated in a partially enlarged view “M” of FIG. 6, it is preferred that the anode and cathode terminals 323 of the photodiode 322 placed in the light-receiving element be connected to bonding pads 631 formed on the PCB 630 using a plurality of wires.

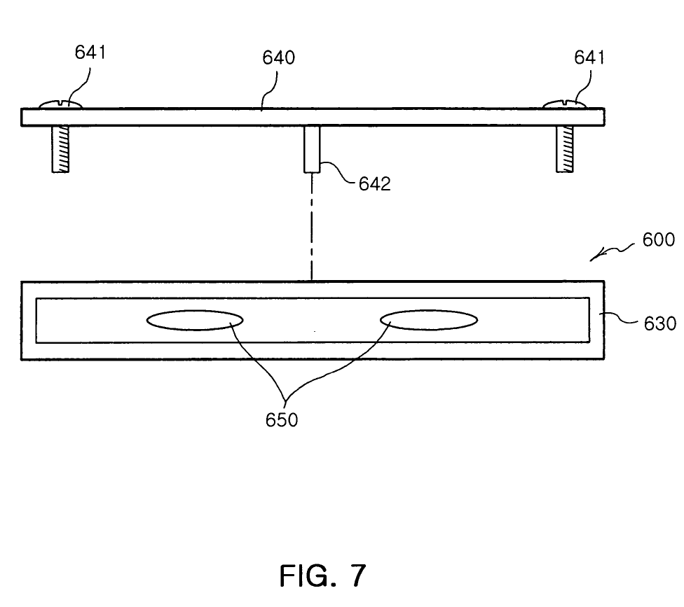

The optical transceiver 600 fabricated as described above requires weld sealing to operate in a wide temperature range regardless of electromagnetic interference. Accordingly, as shown in FIG. 7, the metallic casing 630 is covered with a metallic lid 640. Additionally, the metallic casing 630 and the metallic lid 640 must be brought into tight contact with each other using screws 641. In order to prevent electromagnetic interference between the optical transmission part and optical reception part of the PCB 610 after the metallic lid 640 has been combined with the metallic casing 630, it is preferable to use a T-type metallic lid 640 having a protrusion 642 that is inserted in the space 611 of the PCB 610 and separates the optical transmission part and the optical reception part. Additionally, the silicon optical bench-based optical devices 310 and 320 existing in the metallic casing 640 are coated with silicon gel or an encapsulating agent, thus being protected from the variation of the external environment. As shown in FIG. 7, holes 650 through which the external optical fibers are inserted are formed through the metallic casing 630.

The optical transceiver using the silicon optical bench-based TOSA and ROSA in accordance with the present invention may be fabricated in the following order.

First, the PCB 610 combined with the pin-type electric connector 620 is secured to the metallic casing 630 using screws. After the PCB 610 has been secured into the metallic casing 630, the optical sub-assemblies 301 and 302 mounted with the light-emitting and light-receiving elements 310 and 320 of the present invention are placed and mechanically secured in the metallic casing 630. Thereafter, the light-emitting and light-receiving elements 310 and 320 are connected to the PCB 610 by wire bonding. The silicon optical bench-based optical devices 310 and 320 existing in the metallic casing 640 are coated with silicon gel or an encapsulating agent to be protected from the variation of the external environment. Finally, the metallic casing 630 is covered with the T-type metallic lid 640 using screws 641.

In the optical transmitter part of the optical transceiver 600 using the silicon optical bench-based TOSA and ROSA, the laser diode 312 converts an electrical signal into light and is transmitted to the outside via the optical fiber in the form of a light signal, and part of the light emitted from the laser diode 312 is detected by the power monitoring photodiode 313 attached near the laser diode 312 and is used to adjust the intensity of optical output of the laser diode 312 through the feedback circuit. In the optical reception part, the photodiode 322a converts a light signal, which is incident on the optical fiber from the outside, into an electrical signal. The optical transceiver 600 using the silicon optical bench-based light-emitting and light-receiving elements 310 and 320 according to the present invention has a small size, so that the optical transceiver 600 of the present invention can be applied to a variety of optical transceivers, such as a gigabit interface converter, a small form factor transceiver and a small form pluggable transceiver.

In accordance with the present invention described above, the silicon optical bench-based optical elements can be connected to the optical fibers in a passive alignment manner, so that the prevent invention has the advantage of easily fabricating a small-sized TOSA and ROSA.

Additionally, the optical transceiver according to the present invention has a small size and can perform modulation and demodulation at high-speed transmission speed, so that the present invention is advantageous in that the optical transceiver can be applied to a variety of optical transceivers, such as a gigabit converter, a small form factor transceiver and a small form pluggable transceiver.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A silicon optical bench-based optical sub-assembly, comprising:
an optical fiber ferrule provided with an optical fiber therein;
a silicon optical bench-based optical device provided with an optical device chip for converting optical signals into electrical signals and vice versa, and a groove for placing the optical fiber of the optical fiber ferrule so that the optical fiber can be optically coupled to the optical device chip;
a support provided with concave mounts for mounting the ferrule and the silicon optical bench-based optical device thereon; and
an optical adaptor connected to the support and configured to secure an external optical fiber so that the external optical fiber can be optically coupled to the optical fiber of the optical fiber ferrule.

2. The silicon optical bench-based optical sub-assembly as set forth in claim 1, wherein the silicon optical bench-based optical sub-assembly is attached to the support using an epoxy resin.

3. The silicon optical bench-based optical sub-assembly as set forth in claim 1, wherein the silicon optical bench-based optical device is coated with silicon gel or an encapsulating agent.

4. The silicon optical bench-based optical sub-assembly as set forth in claim 1, wherein the optical fiber ferrule comprises:
a stub provided with the optical fiber therethrough; and
an outside hollow cylinder made of material identical to material of the stub and configured to surround the stub.

5. The silicon optical bench-based optical sub-assembly as set forth in claim 4, wherein the stub and the outside hollow cylinder are made of ceramic.

6. The silicon optical bench-based optical sub-assembly as set forth in claim 1, wherein the silicon optical bench-based optical device comprises:
a laser diode; and
a photodiode for detecting part of light output from the laser diode and controlling intensity of optical output of the laser diode.

7. The silicon optical bench-based optical sub-assembly as set forth in claim 6, wherein the laser diode and the photodiode are bonded on the silicon optical bench using solder bumps in a flip chip bonding manner.

8. The silicon optical bench-based optical sub-assembly as set forth in claim 1, wherein the silicon optical bench-based optical device comprises a photodiode for converting optical signals, which is incident from outside, into electrical signals.

9. The silicon optical bench-based optical sub-assembly as set forth in claim 1, wherein the silicon optical bench-based optical device and the optical fiber ferrule are optically coupled to each other in receptacle form.

10. An optical transceiver comprising:
at least one optical sub-assembly including, an optical fiber ferrule provided with an optical fiber therein, a silicon optical bench-based optical device provided with an optical device chip for converting optical signals into electrical signals and vice versa, and a groove for placing the optical fiber of the optical fiber ferrule so that the optical fiber can be optically coupled to the optical device chip, a support provided with concave mounts for mounting the ferrule and the silicon optical bench-based optical device thereon, and an optical adaptor connected to the support and configured to secure an external optical fiber so that the external optical fiber can be optically coupled to the optical fiber of the optical fiber ferrule;
a Printed Circuit Board (PCB) connected to the optical sub-assembly and configured to perform control, amplification and identification of electrical signals on the silicon optical bench-based optical device;
a pin-type electric connector connected to the PCB and configured to function as an interface with external devices; and
a casing configured to contain the optical sub-assembly, the PCB and the pin-type electric connector.

11. The optical transceiver as set forth in claim 10, wherein the silicon optical bench-based optical device of the optical sub-assembly and the PCB are connected to each other using a plurality of wires.

12. The optical transceiver as set forth in claim 10, wherein the PCB is provided with a space between an optical transmission part and an optical reception part to prevent performance degradation caused by electromagnetic interference.

13. The optical transceiver as set forth in claim 12, further comprising a metallic lid for sealing the casing, the metallic lid being provided with a partition that is inserted into the space of the PCB and that separates the optical transmission part and the optical reception part from each other.

14. The optical transceiver as set forth in claim 10, wherein a ground pin of the pin-type electric connector is connected to a ground terminal of the PCB and the casing.

15. The optical transceiver as set forth in claim 10, wherein the casing is made of metal.
